(19) United States
(12) Patent Application Publication
(10) Pub. No.: US 2018/0299101 A1
(43) Pub. Date: Oct. 18, 2018

(54) REFLECTIVE ARTICLES AND METHOD OF MANUFACTURING

(71) Applicant: SABIC GLOBAL TECHNOLOGIES B.V., Bergen op Zoom (NL)

(72) Inventors: Wei ZHAO, Evansville, IN (US); Xiaoyu SUN, Evansville, IN (US)

(21) Appl. No.: 15/526,435

(22) PCT Filed: Nov. 5, 2015
(86) PCT No.: PCT/US2015/059238

§ 371 Date: May 12, 2017

Related U.S. Application Data
(60) Provisional application No. 62/080,472, filed on Nov. 17, 2014.

(51) Int. Cl. F21V 7/24; G03B 15/03

(52) U.S. Cl. CPC F21V 7/24; G02B 19/0061; G03B 15/03

(57) ABSTRACT

A reflective article includes a reflector and a light source. The reflector includes a polymer layer having a first side configured to house a light source, and an opposite second side, and a metal layer disposed on the opposite second side of the polymer layer. The light source is located adjacent to the first side of the polymer layer. A method of making the reflective article is provided, including providing the above-described reflector, and locating a light source adjacent to the first side of the polymer layer. A method of making the reflector is also provided, including providing the polymer layer having a first side configured to house a light source, and an opposite second side, and metallizing at least a portion of the second side. The reflective article is useful for mobile electronic devices.

### BACKGROUND

Electronic devices such as portable computers, tablet computers, and cellular telephones are often provided with cameras having a flash module. Flash modules include a light source, such as a light emitting diode, to provide illumination where needed. The light source can be located in a housing configured to house the light source. These housings often include polymeric materials due to the associated advantageous thermal and mechanical properties, as well as processing advantages. The polymeric housing, which is typically white, provides for confinement of the light emitted from the light source and reflects the light towards the objects to be illuminated.

Recent efforts have focused on decreasing the size of such electronic devices. Accordingly, the size of the components, including the flash module, has been decreased, resulting in thin polymeric housings. As the housings become very thin, for example below 1 millimeter, light emitted from the light source can penetrate the housing as shown schematically in FIG. 1. In FIG. 1, a housing (1) having a thickness of, for example 1 millimeter or less, comprises a light source (2) located on a side of the housing. The light source emits light (3). While a portion of the emitted light is reflected (4) by the housing, a portion of the emitted light is transmitted through the housing (5). This results in decreased reflectance of the light (i.e., decreased light intensity), which is undesirable when using the camera to take pictures.

There is an active interest in overcoming the above-described technical limitations of light leaching through a housing configured to house a light source. Accordingly, there remains a need for improving the reflectance of a polymeric material configured to house a light source, to reduce the amount of undesired light leaching through the housing.

### BRIEF DESCRIPTION

A reflective article comprises a reflector comprising a polymer layer comprising a first side configured to house a light source, and an opposite second side, and a metal layer disposed on the opposite second side of the polymer layer; and a light source located adjacent to the first side of the polymer layer.

A method of making the reflective article comprises providing the reflector; and locating a light source adjacent to the first side of the polymer layer.

A method of making the reflector comprises providing a polymer layer comprising a first side configured to house a light source, and an opposite second side; and metallizing at least a portion of the second side.

A reflector comprises a polymer layer, wherein the polymer layer comprises a first side configured to house a light source and an opposite second side, comprises a polymer having thermal decomposition temperature of 180° C. or higher, preferably an aromatic polyetherimide or a polycarbonate comprising repeat units derived from bisphenol A, N-phenyl phenolphthalein bisphenol, isophorone bisphenol, or a combination comprising at least one or the foregoing, and has thickness of 3 micrometers to 3 millimeters; and a metal layer disposed on the opposite second side of the polymer layer, preferably wherein the metal layer has a thickness of 1 to 1000 nanometers, preferably 10 to 500 nanometers, more preferably 50 to 250 nanometers, most preferably 100 to 200 nanometers. A reflective article comprises the above-described reflector, and a light source located adjacent to the first side of the polymer layer.

A mobile electronic device comprises the reflective article.

The above described and other features are exemplified by the following Figures and Detailed Description.

### BRIEF DESCRIPTION OF THE DRAWINGS

The following Figures are exemplary embodiments, wherein like elements are numbered alike.

FIG. 1 depicts a cross-sectional view of a polymer layer in the form of a housing (1) configured to house a light source (2), wherein light leaches through the housing (5) when the housing walls are thin (e.g., 1 millimeter or less).

FIG. 2 depicts a cross-sectional view of a polymer layer in the form of a housing (1) configured to house a light source (2) having a metal layer (6) disposed on a side of the housing opposite the light source.

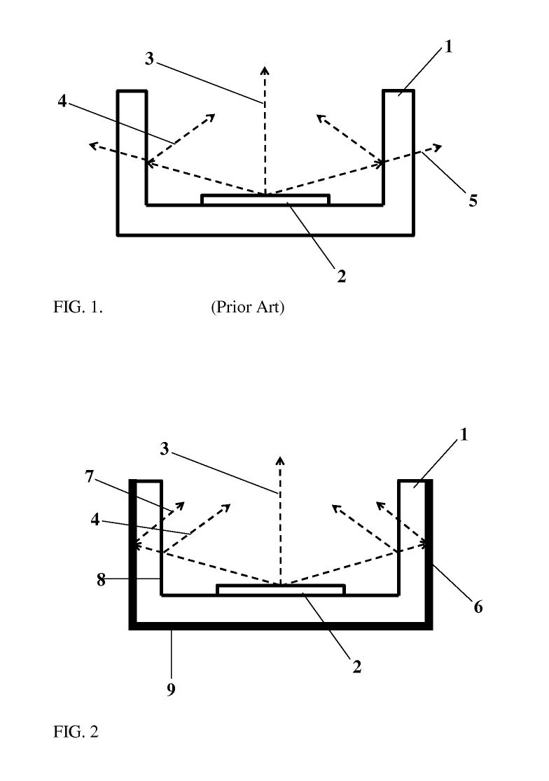

### DETAILED DESCRIPTION

Described herein is a reflective article comprising a reflector and a light source. The reflector comprises a polymer layer having a first side and an opposite second side. The first side of the polymer layer can be configured to house the light source, and the light source is located adjacent the first side of the polymer layer. A metal layer is disposed on the opposite second side of the polymer layer. The inventors hereof have unexpectedly discovered that the use of a metal layer opposite the light source allows the manufacture of very thin reflectors that have excellent reflection properties, with greatly reduced light leaching through the polymer layer. The reflectors and reflective articles can advantageously be processed at high temperatures, e.g., at temperatures greater than or equal to 180° C. The reflectors and reflective articles are useful in handheld devices, for example in a flash module for a mobile handheld device.

The reflective article comprises a reflector comprising a polymer layer and a reflective metal layer. The polymer layer of the reflector comprises a high temperature thermoplastic polymer. High temperature thermoplastic polymers have a thermal decomposition temperature of 180° C. or higher, preferably 200° C. or higher, more preferably 220° C., or higher, or most preferably 250° C. or higher. There is no particular upper limit, although 400° C. may be mentioned. The polymers are preferably also hydrolytically stable at high temperatures, for example 180° C. or higher, preferably 200° C. or higher, more preferably 220° C., or higher, or most preferably 250° C. or higher.

Thermoplastic polymers can be used since they are readily shaped, for example molded. Thermoplastic polymers that can meet these conditions generally contain aromatic groups, for example polyphthalamides (PPA), aromatic polyimides, aromatic polyetherimides, polyphenylene sulfides (PPS), polyaryletherketones (PAEK), polyetherether ketones (PEEK), polyetherketoneketones (PEKK), polyethersulfones (PES), polyphenylenesulfones (PPSU), polyphenylenesulfone ureas, certain polycarbonates, or the like. A combination comprising at least one of the foregoing can be used. The thermoplastic polymers can be linear or branched and include homopolymers or copolymers comprising units of two or more of the foregoing thermoplastic polymers, for example polyamide-imides (PAI). The copolymers can be random, alternating, graft, and block copolymers having two or more blocks of different homopolymers, random, or alternating copolymers. In some embodiments, the high temperature polymers are the aromatic polyetherimides available from SABIC under the trade name ULTEM. The high temperature thermoplastic polymers can be obtained and used in either pellet or powder form.

In another embodiment, the high temperature thermoplastic polymer is a polycarbonate. “Polycarbonate” as used herein means a polymer or copolymer having repeating structural carbonate units of formula (1)

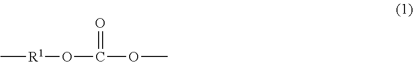

wherein at least 60 percent of the total number of R¹ groups are aromatic, or each R¹ contains at least one C₆₋₃₀ aromatic group. Specifically, each R¹ can be derived from a dihydroxy compound such as an aromatic dihydroxy compound of formula (2) or a bisphenol of formula (3).

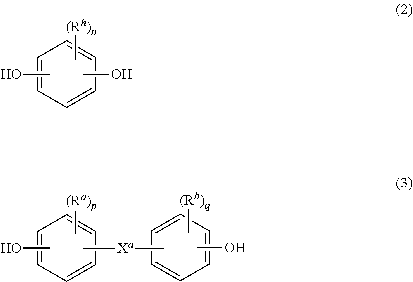

In formula (2), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In formula (3), R^{a} and R^{b} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In some embodiments, p and q is each 0, or p and q is each 1, and R^{a} and R^{b} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorus. For example, X^{a} can be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Some illustrative examples of specific dihydroxy compounds include bisphenol compounds such as 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like.

Specific dihydroxy compounds include resorcinol, 2,2-bis(4-hydroxyphenyl) propane (“bisphenol A” or “BPA”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane (DMBPC), and from bisphenol A and 1,1-bis(4-hydroxy-3-methylphenyl)-3,3,5-trimethylcyclohexane (isophorone bisphenol).

“Polycarbonate” as used herein also includes copolymers, including copolycarbonates prepared from two or more different dihydric phenols. A specific copolycarbonate includes bisphenol A and bulky bisphenol carbonate units, i.e., derived from bisphenols containing at least 12 carbon atoms, for example 12 to 60 carbon atoms or 20 to 40 carbon atoms. Another copolycarbonate is a poly(carbonate-siloxane) comprising bisphenol A carbonate units and siloxane units, for example blocks containing 5 to 200 dimethylsiloxane units, such as those commercially available under the trade name EXL from the Innovative Plastics division of SABIC.

Examples of useful polycarbonates include bisphenol A homopolycarbonate and copolycarbonates comprising bisphenol A carbonate units and 2-phenyl-3,3′-bis(4-hydroxyphenyl) phthalimidine carbonate units (a BPA-PPPBP copolymer, commercially available under the trade designation XHT from the Innovative Plastics division of SABIC), a copolymer comprising bisphenol A carbonate units and 1,1-bis(4-hydroxy-3-methylphenyl)cyclohexane carbonate units (a BPA-DMB PC copolymer commercially available under the trade designation DMC from the Innovative Plastics division of SABIC), and a copolymer comprising bisphenol A carbonate units and isophorone bisphenol carbonate units (available, for example, under the trade name APEC from Bayer). In a specific embodiment, the high temperature thermoplastic polymer comprises repeat units derived from BPA and PPPBP (commercially available under the trade designation XHT from the Innovative Plastics division of SABIC). Combinations of any of the above materials can be used, for example a melt-blended combination of a BPA-PPPBP copolymer and a bisphenol A homopolycarbonate in weight ratio of 5:95 to 95:5 wherein the melt-blending is in the presence of 0.001 to 0.1 weight percent (wt %) of a transesterification catalyst, as described in U.S. Pat. No. 7,491,788. Polycarbonates that contribute opacity can also be used, for example poly(carbonate-siloxane)s comprising bisphenol A carbonate units and siloxane units, in amounts of about 5 to about 30 wt %, based on the total weight of the compositions.

The thermoplastic polymers can have a weight average molecular weight (Mw) of about 1,000 to about 200,000 grams per mole (g/mol), preferably about 1,000 to about 100,000 g/mol, as measured by gel permeation chromatography (GPC). The thermoplastic polymers can have a melt flow of 1 gram per 10 minutes (g/10 minutes) or higher, preferably 10 g/10 minutes or higher, up to 7,500 g/10 minutes, each determined according to ASTM D 1283 at 316° C. under a 5 kg load, and in another embodiment greater than about 50 g/10 minutes.

The polymer layer of the reflector is desirably opaque to improve the reflection of the light emitted from the light source. The polymer layer can further be any color with the proviso that the color is selected so as to not significantly adversely affect the desired reflectance of the polymer layer. For example, the polymer layer can be a white polymer layer. In some embodiments, the polymer layer optionally comprises an opacifier to improve the opacity of the polymer layer. Exemplary opacifiers include titanium dioxide (TiO₂), fumed silica, mixed metal oxides containing titania such as metal titanates, lead oxide, zinc oxide, antimony oxide, other similar whitening agents, or a combination comprising at least one of the foregoing. For example, in some embodiments, the filler is TiO₂. When present, an opacifier can be in an amount of 0.1 to 30 wt %, preferably 1 to 20 wt %, each based on the total weight of the polymer layer.

The polymer layer of the reflector can have any thickness, but polymer layers having a thickness of less than or equal to 3 millimeters (mm) are preferred. For example, the polymer layer can have a thickness of 3 micrometers to 3 millimeters, for example 5 micrometers to 1 millimeter, for example 10 micrometers to 0.5 millimeters, for example 50 micrometers to 0.3 millimeters.

The polymer layer of the reflector can generally have any shape, for example it can be flat or three-dimensional. For example, the polymer layer can be rectangular, circular, hemi-spherical, parabolic, cone-shaped, frustoconical, square-shaped, wedge-shaped, and any other suitable shape. In some embodiments, including the embodiment wherein the polymer layer is flat, the first side of the polymer layer is configured to house a light source.

General techniques for preparing the polymer layer are known to those skilled in the art. For example, the polymer layer can be prepared by molding, for example injection molding, melt extrusion, or solution casting. In some embodiments, the polymer layer is prepared by injection molding.

The polymer layer can optionally include an additive composition. The additive composition can include one or more additives selected to achieve a desired property, with the proviso that the additive(s) are also selected so as to not significantly adversely affect a desired property of the polymer layer. The additive composition or individual additives can be mixed at a suitable time during the mixing of the components for forming the composition. The additive can be soluble or non-soluble in the high temperature thermoplastic polymer.

The additive composition can include an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g, a dye or pigment), surface effect additive, radiation stabilizer, flame retardant, anti-drip agent (e.g., a PTFE-encapsulated styrene-acrylonitrile copolymer (TSAN)), or a combination comprising one or more of the foregoing. For example, a combination of a heat stabilizer, mold release agent, and ultraviolet light stabilizer can be used. In general, the additives are used in the amounts generally known to be effective. For example, the total amount of the additive composition (other than any impact modifier, filler, or reinforcing agent) can be 0.001 to 10.0 wt %, or 0.01 to 5 wt %, each based on the total weight of the polymer in the polymer layer.

A metal layer of the reflector is disposed on at least a portion of a side of the polymer layer. The metal layer can include the metals of Groups IIIA, IIIB, IVB, VB, VIB, VIIB, VIII, IB, and IIB of the periodic table. Mixtures and alloys of these metals can also be used. For example, the metal layer can be aluminum, silver, copper, gold, nickel, palladium, platinum, and the like, and alloys comprising at least one of the foregoing. In some embodiments, the metal layer comprises gold.

The metal layer can be deposited on the polymer layer by any techniques which are generally known, for example, electroplating, electroless plating, sputtering, vacuum metal deposition, vapor arc deposition, plasma chemical vapor deposition, thermal vapor metal deposition, ion plating, adhering a metal foil, and the like. “Adhering a metal foil” can be by an adhesive, for example, or by overmolding the polymer layer onto the metal foil. Additional metal layers can be disposed on the first metal layer to provide a metal multilayer disposed on at least a portion of a side of the polymer layer.

The metal layer can have a thickness of 1 to 1000 nanometers (nm), for example 10 to 500 nm, for example 50 to 250 nm, or for example 100 to 200 nm.

In some embodiments, the metal layer is disposed directly on the polymer layer of the reflector. Alternatively, one or more intervening layers can be disposed between the metal layer and the polymer layer. An intervening layer can be, for example, an adhesive layer, a primer layer, or the like. In some embodiments, a clear protective layer can be disposed on the metal layer to protect the metal layer from scratching, oxidation, or related problems.

The reflective articles disclosed herein further comprise a light source. The light source can be a fluorescent lamp, a cathode-luminescence phosphor lamp, a light emitting diode (LED), an organic light emitting diode (OLED), a plasma lighting system (PLS), a laser, or any other component or device that is capable of providing illumination. For example, the light source is a light emitting diode (LED), for example, a white LED (i.e., a LED that emits white light). A white LED typically consists of a blue LED that illuminates a yellow phosphor. The overall output is a blue component (arising from light from the LED that is not absorbed) and a yellow component re-emitted by the phosphor, and the light from each component combines to create white light. Alternatively, some or all of the light sources can be ultra-violet LEDs or infra-red LEDs, for example, the light source can emit ultra-violet or infra-red light. In some embodiments, one or more LEDs can be used.

The light source is located adjacent a first side of the polymer layer. As used herein, the term “located adjacent a first side” is meant to describe the relative positions of the light source, the polymer layer, and the metal layer of the reflector, in that the light source is located on the side of the polymer layer opposite to the metal layer. The light source can be coupled to the polymer layer, where “coupled” is defined as connected, whether directly or indirectly, through intervening components and is not necessarily limited to physical connections.

In some embodiments, the reflective article comprising the reflector and the light source can be configured according to the article depicted in FIG. 2. FIG. 2 shows a cross-sectional view of a polymer layer in the form of a square-shaped housing (1), configured to house the light source (2). The light source (2) is located on a first side (8) of the polymer layer. A metal layer (6) is disposed on an opposite second side (9) of the polymer layer (6). The light source emits light (3), and a portion of the light is reflected by the polymer layer (4). A second portion of the light is transmitted through the polymer layer and is subsequently reflected (7) by the presence of the metal layer (6) on the second opposite side of the polymer layer.

Also disclosed herein are methods for making the reflector and the reflective article.

A method for making the reflector comprises providing the polymer layer having a first side and an opposite second side, and metallizing the polymer layer on the second side thereof, as described above. In a specific embodiment, the polymer layer is formed, for example injection molded, and then metallized.

A method of making the reflective article includes providing the reflector and locating the light source adjacent to the first side of the polymer layer of the reflector. In a specific embodiment, the method comprises forming the polymer layer having a first side and an opposite second side, preferably by injection molding; metallizing at least a portion of the second side of the polymer layer to provide a reflector, and locating the light source adjacent to the first side of the polymer layer.

The reflectors and reflective articles can reflect at least 90 percent of light emitted from a light source, preferably at least 95 percent of light emitted from a light source, more preferably at least 99 percent of light emitted from a light source.

The reflector and reflective articles can have reduced transmittance through the reflector. For example, the percent light transmittance through the reflector is reduced by greater than or equal 90 percent, preferably greater than or equal to 95 percent compared to the same reflector not having the metal layer disposed on the polymer layer on a side opposite the light source.

The reflector can resist deformation as determined by IPC method TM-650 (2.6.27) when subjected to a solder reflow process at a temperature greater than or equal to 180° C., preferably 180 to 265° C., for example 180 to 250° C. or 180 to 250° C.

The reflectors and reflective articles can advantageously be used in many applications, for example, mobile electronic devices. Mobile electronic devices include, for example, hand held mobile telephones, personal digital assistants, laptop computers, tablet computers, global positioning system receivers, portable games, radios, cameras and camera accessories, televisions, or the like. Such mobile electronics can include the reflective article disclosed herein. For example, the reflective article can advantageously be used as a flash module for a mobile electronic device.

The reflectors and reflective articles demonstrate improved reflective properties, and are compatible with materials and manufacturing processes in which such articles are used, for example, mobile electronic devices. Therefore, a substantial improvement in reflective articles is provided.

The reflectors, reflective articles, and methods of manufacture thereof are further illustrated by the following non-limiting examples.

### EXAMPLES

High-heat formulations as shown in Table 1 were used to prepare reflector polymer layers for testing. The amounts shown are approximate weight percent, based on the total weight of the composition (amounts may not total 100 wt %, due to rounding). Polymer layers having a thickness of 3 mm were prepared by injection molding, and the color properties and transmittance were measured. Results are also shown in Table 1.

TABLE 1

| | | Formu- | Formu- |
|---|---|---|---|
| Component | | lation 1 | lation 2 |
| PPPBP/BPA-PC | | 70-80 | 65-75 |
| (Copolycarbonate comprising repeat units | | | |
| derived from BPA and PPPBP, from SABIC) | | | |
| BPA-PC | | 7-12 | — |
| (BPA homopolycarbonate 100 grade, from | | | |
| SABIC) | | | |
| BPA-PC | | 7-15 | — |
| (BPA homopolycarbonate, high flow, from | | | |
| SABIC) | | | |
| Si-PC | | — | 5-20 |
| (BPA-polydimethylsiloxane copolymer, | | | |
| opaque, from SABIC) | | | |
| Phosphite stabilizer | | 0.01-3 | 0.01-3 |
| Mold release agent | | 0.1-1 | 0.1-1 |
| Hindered phenol stabilizer | | 0.01-1 | 0.01-1 |
| TiO₂ | | 5-25 | 5-30 |
| Reflection method | L | 97.92 | 97.83 |
| (with white backing) | a | −1.55 | −1.53 |
| | b | 3.14 | 3.27 |

| | | |
|---|---|---|
| Percent Transmittance | 5.03 | 2.422 |

Reflectors (Example 1 and Example 2) were prepared from samples of Formulation 1 and Formulation 2, respectively, by metallizing each sample on a side by sputtering under vacuum with gold (obtained from Ted Pella), using a Cressington Sputter Coater 108 auto control unit to form the metal layer. The thickness of the metal layer was calculated using the equation

D=K*I*T

in which D is the film thickness in Angstrom, K is the material constant (about 0.17 for gold), I is the sputtering current in mA, and T is the coating time in second. Comparative Examples 1 and 2 (made from Formulations 1 and 2, respectively), were not provided with a metal layer.

An LED light source was located on a side of the polymer layer opposite from the metal layer. The percent light transmitted through Comparative Examples 1 and 2 and Examples 1 and 2 was measured, and the results are presented in Table 2.

TABLE 2

| | Comp. | | Comp. | |
|---|---|---|---|---|
| Sample | Ex. 1 | Ex. 1 | Ex. 2 | Ex. 2 |
| Polymer layer thickness (mm) | 3 | 3 | 3 | 3 |
| Metal layer thickness (nm) | — | 122.4 | — | 163.2 |
| Light transmittance (%) | 5.03 | 0.19 | 2.42 | 0.04 |

Comparative examples 1 and 2 illustrate that about 2 to 5 percent of light is transmitted through a 3 millimeter polymer layer, depending on the composition of the polymer layer. Example 1 employs a 122.4 nm gold layer disposed on one side of the 3 millimeter-thick polymer layer, and demonstrates that the light transmittance can be reduced to 0.19% transmittance, representing a 96% decrease relative to Comparative Example 1. Example 2 employs a slightly thicker layer of gold (163.2 nm) and shows a further reduction in light transmittance through the polymer layer of 0.04%. The percent light transmittance for Example 2 was about 98% less than the transmittance of Comparative Example 2. Thus, the thickness of the metal layer can be correlated to percent light transmittance through the article.

The reflectors, reflective articles, and methods of manufacture thereof are further illustrated by the following embodiments, which are non-limiting.

Embodiment 1: A reflective article, comprising a reflector comprising a polymer layer comprising a first side configured to house a light source, and an opposite second side, and a metal layer disposed on the opposite second side of the polymer layer; and a light source located adjacent to the first side of the polymer layer.

Embodiment 2: The article of embodiment 1, wherein the reflector reflects at least 90 percent of light emitted from the light source, preferably at least 95 percent of light emitted from the light source, more preferably at least 99 percent of light emitted from the light source.

Embodiment 3: The article of any one or more of embodiments 1 to 2, wherein the percent light transmittance through the reflector is reduced by greater than or equal to 90 percent, preferably greater than or equal to 95 percent, compared to the same reflector without the metal layer.

Embodiment 4: The article of any one or more of embodiments 1 to 3, wherein the reflector resists deformation as determined by IPC method TM-650 (2.6.27) when subjected to a solder reflow process at a temperature greater than or equal to 160° C., preferably 180 to 265° C.

Embodiment 5: The article of any one or more of embodiments 1 to 4, wherein the polymer layer comprises a high temperature thermoplastic polymer having a glass transition temperature of 180° C. or higher, preferably 200° C. or higher, more preferably 220° C., or higher, or 180 to 265° C.

Embodiment 6: The article of embodiment 5, wherein the high temperature thermoplastic polymer comprises a polyphthalamide, aromatic polyimide, aromatic polyetherimide, polyphenylene sulfide, polyaryletherketone, polyetherether ketone, polyetherketone ketone, polyethersulfone, polyphenylenesulfone, polyphenylenesulfone urea, polycarbonate, or a combination comprising at least one of the foregoing polymers.

Embodiment 7: The article of any one or more of embodiments 5 to 6, wherein the high temperature thermoplastic polymer comprises a polycarbonate comprising repeat units derived from bisphenol A, N-phenyl phenolphthalein bisphenol, isophorone bisphenol, or a combination comprising at least one or the foregoing.

Embodiment 8: The article or any one or more of embodiments 5 to 6, wherein the high temperature thermoplastic polymer comprises an aromatic polyetherimide.

Embodiment 9: The article of any one or more of embodiments 1 to 8, wherein the polymer layer has a thickness of 3 micrometers to 3 millimeters, preferably 5 micrometers to 1 millimeter, more preferably 10 micrometers to 0.5 millimeter, most preferably 50 micrometer to 0.3 millimeter.

Embodiment 10: The article of any one or more of embodiments 1 to 9, wherein the metal layer comprises a metal of Group IIIA, IIIB, IVB, VB, VIB, VIIB, VIII, IB, or IIB of the periodic table, preferably aluminum, silver, copper, gold, nickel, palladium, platinum, or an alloy comprising at least one of the foregoing.

Embodiment 11: The article of any one or more of embodiments 1 to 10, wherein the metal layer has a thickness of 1 to 1000 nanometers, preferably, 10 to 500 nanometers, more preferably 50 to 250 nanometers, most preferably 100 to 200 nanometers.

Embodiment 12: The article of any one or more of embodiments 1 to 11, wherein the polymer layer further comprises an opacifier to improve the opacity of the polymer layer, preferably titanium dioxide, fumed silica, a mixed metal oxide containing titania such as a metal titanate, lead oxide, zinc oxide, antimony oxide, or a combination comprising at least one of the foregoing.

Embodiment 13: The article of any one or more of embodiments 1 to 12, wherein the first side of the polymer layer is configured to house the light source.

Embodiment 14: The article of any one or more of embodiments 1 to 13, wherein the polymer layer is a white polymer layer.

Embodiment 15: The article of any one or more of embodiments 1 to 14, wherein the light source is a light emitting diode.

Embodiment 16: A mobile electronic device comprising the article of any one or more of embodiments 1 to 15.

Embodiment 17: A method of making the reflective article of any one or more of embodiments 1 to 15, the method comprising providing the reflector as described in any one or more of embodiments 1 to 15; and locating a light source adjacent the first side of the polymer layer.

Embodiment 18: A method of making the reflector of any one or more of embodiments 1 to 15, the method comprising providing a polymer layer comprising a first side configured to house a light source, and an opposite second side; metallizing at least a portion of the second side.

Embodiment 19: The method of embodiment 18, wherein the providing comprises forming the polymer layer, preferably injection molding the polymer layer.

Embodiment 20: The method of any one or more of embodiments 18 to 19, wherein the metallizing is by electroplating, electroless plating, sputtering, vacuum metal deposition, vapor arc deposition, plasma chemical vapor deposition, thermal vapor metal deposition, ion plating, or adhering a metal foil.

Embodiment 21: A reflector, comprising a polymer layer, wherein the polymer layer comprises a first side configured to house a light source and an opposite second side, comprises a polymer having thermal decomposition temperature of 180° C. or higher, preferably an aromatic polyetherimide or a polycarbonate comprising repeat units derived from bisphenol A, N-phenyl phenolphthalein bisphenol, isophorone bisphenol, or a combination comprising at least one or the foregoing, and has thickness of 3 micrometers to 3 millimeter; and a metal layer disposed on the opposite second side of the polymer layer, preferably wherein the metal layer has a thickness of 1 to 1000 nanometers, preferably 10 to 500 nanometers, more preferably 50 to 250 nanometers, most preferably 100 to 200 nanometers.

Embodiment 22: A reflective article, comprising the reflector of embodiment 21; and a light source located adjacent to the first side of the polymer layer.

Embodiment 23: A mobile electronic device comprising the reflective article of embodiment 22.

Embodiment 24: The mobile electronic device of embodiment 16 or embodiment 23, wherein the reflective article is a component of a camera flash.

In general, the invention may alternatively comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other. “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. It is to be understood that the described elements may be combined in any suitable manner in the various embodiments.

As used herein, the term “hydrocarbyl” includes groups containing carbon, hydrogen, and optionally one or more heteroatoms (e.g., 1, 2, 3, or 4 atoms such as halogen, O, N, S, P, or Si). “Alkyl” means a branched or straight chain, saturated, monovalent hydrocarbon group, e.g., methyl, ethyl, i-propyl, and n-butyl. “Alkylene” means a straight or branched chain, saturated, divalent hydrocarbon group (e.g., methylene (—CH₂—) or propylene (—(CH₂)₃—)). “Alkenyl” and “alkenylene” mean a monovalent or divalent, respectively, straight or branched chain hydrocarbon group having at least one carbon-carbon double bond (e.g., ethenyl (—HC═CH₂) or propenylene (—HC(CH₃)═CH₂—). “Alkynyl” means a straight or branched chain, monovalent hydrocarbon group having at least one carbon-carbon triple bond (e.g., ethynyl). “Alkoxy” means an alkyl group linked via an oxygen (i.e., alkyl-O—), for example methoxy, ethoxy, and sec-butyloxy. “Cycloalkyl” and “cycloalkylene” mean a monovalent and divalent cyclic hydrocarbon group, respectively, of the formula —CₙH₂ₙ₋ₓ and —CₙH₂ₙ₋₂ₓ— wherein x is the number of cyclization. “Aryl” means a monovalent, monocyclic, or polycyclic aromatic group (e.g., phenyl or naphthyl). “Arylene” means a divalent, monocyclic, or polycyclic aromatic group (e.g., phenylene or naphthylene). The prefix “halo” means a group or compound including one more halogen (F, Cl, Br, or I) substituents, which can be the same or different. The prefix “hetero” means a group or compound that includes at least one ring member that is a heteroatom (e.g., 1, 2, or 3 heteroatoms, wherein each heteroatom is independently N, O, S, or P.

“Substituted” means that the compound or group is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g, benzyl), C₇₋₁₂ alkylarylene (e.g, toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the group, including those of the substituents. All references are incorporated herein by reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

I/We claim:

1. A reflective article, comprising
a reflector comprising
a polymer layer comprising a first side configured to house a light source, and an opposite second side, and
a metal layer disposed on the opposite second side of the polymer layer; and
a light source located adjacent to the first side of the polymer layer.

2. The article of claim 1, wherein
the reflector reflects at least 90 percent of light emitted from the light source;
the percent light transmittance through the reflector is reduced by greater than or equal to 90 percent, compared to the same reflector without the metal layer; and
the reflector resists deformation as determined by IPC method TM-650 (2.6.27) when subjected to a solder reflow process at a temperature greater than or equal to 160° C.

3. The article of claim 1, wherein the polymer layer comprises a high temperature thermoplastic polymer having a glass transition temperature of 180° C. or higher.

4. The article of claim 3, wherein the high temperature thermoplastic polymer comprises a polyphthalamide, aromatic polyimide, aromatic polyetherimide, polyphenylene sulfide, polyaryletherketone, polyetherether ketone, polyetherketone ketone, polyethersulfone, polyphenylenesulfone, polyphenylenesulfone urea, polycarbonate, or a combination comprising at least one of the foregoing polymers.

5. The article of claim 3, wherein the high temperature thermoplastic polymer comprises a polycarbonate comprising repeat units derived from bisphenol A, N-phenyl phenolphthalein bisphenol, isophorone bisphenol, or a combination comprising at least one or the foregoing.

6. The article of claim 3, wherein the high temperature thermoplastic polymer comprises an aromatic polyetherimide.

7. The article of claim 1, wherein the polymer layer has a thickness of 3 micrometers to 3 millimeters.

8. The article of claim 1, wherein the metal layer comprises a metal of Group IIIA, IIIB, IVB, VB, VIB, VIIB, VIII, IB, or IIB of the periodic table.

9. The article of claim 1, wherein the metal layer has a thickness of 1 to 1000 nanometers.

10. The article of claim 1, wherein the polymer layer further comprises an opacifier to improve the opacity of the polymer layer.

11. The article of claim 1, wherein the first side of the polymer layer is configured to house the light source.

12. The article of claim 1, wherein the polymer layer is a white polymer layer.

13. A mobile electronic device comprising the article of claim 1.

14. A method of making the reflective article of claim 1, the method comprising
providing the reflector as described in claim 1; and
locating a light source adjacent the first side of the polymer layer.

15. A method of making the reflector of claim 1, the method comprising
providing a polymer layer comprising a first side configured to house a light source, and an opposite second side; and
metallizing at least a portion of the second side.

16. The method of claim 15, wherein the providing comprises forming the polymer layer.

17. The method of claim 15, wherein the metallizing is by electroplating, electroless plating, sputtering, vacuum metal deposition, vapor arc deposition, plasma chemical vapor deposition, thermal vapor metal deposition, ion plating, or adhering a metal foil.

18. A reflector, comprising
a polymer layer, wherein the polymer layer
comprises a first side configured to house a light source and an opposite second side,
comprises a polymer having thermal decomposition temperature of 180° C. or higher, and
has thickness of 3 micrometers to 3 millimeters; and
a metal layer disposed on the opposite second side of the polymer layer.

19. A reflective article, comprising
the reflector of claim 18; and
a light source located adjacent to the first side of the polymer layer.

20. A mobile electronic device comprising the reflective article of claim 19, wherein the reflective article is a component of a camera flash.
